(19) United States
(12) Patent Application Publication
(10) Pub. No.: US 2019/0072085 A1
(43) Pub. Date: Mar. 7, 2019

(54) PORTABLE SOLAR POWERED FLUID DISPENSER FOR RELEASE AGENTS

(71) Applicant: Allan Schultz, New Richland, MN (US)

(72) Inventor: Allan Schultz, New Richland, MN (US)

(21) Appl. No.: 16/107,647

(22) Filed: Aug. 21, 2018

Related U.S. Application Data
(60) Provisional application No. 62/554,891, filed on Sep. 6, 2017.

(51) Int. Cl. F04B 17/00; B05B 9/04; B05B 15/40; B28B 7/38

(52) U.S. Cl. CPC F04B 17/006; B05B 9/0403; B05B 15/62; B28B 7/388; B05B 15/40

(57) ABSTRACT

A self-contained portable solar powered fluid pump dispenser for concrete release agents having a movable supporting base pallet upon which a bulk container of release agent fluid is carried, along with a supporting framework which carries a solar panel, electric pump and rechargeable battery that is energized by the solar panel. An elongated dispensing hose is coiled on a hose reel carried by the supporting framework, such that the dispensing hose and dispensing wand connected thereto may be efficiently stored when not in use. The solar powered pump is fluidly sealed between the bulk container of release agent fluid and the dispensing wand to prevent undesirable contaminants from entering the fluid dispensing system.

### CROSS REFERENCE TO RELATED APPLICATIONS

This application is a nonprovisional application which claims the benefit of U.S. Provisional Application Ser. No. 62/554,891, filed on Sep. 6, 2017, the contents of which is hereby incorporated by reference herein in its entirety.

### FIELD OF INVENTION

The present invention relates generally to the field of fluid dispensers, and more particularly fluid dispensers used in construction projects for the application of release agents to concrete forms. Even more specifically, the present invention pertains to a solar powered fluid dispenser for release agents which is readily transportable and has an extended reach capability for convenience of use.

### BACKGROUND

The statements in this section merely provide background information related to the present disclosure and may not constitute prior art.

Release agents are widely used in many industries to prevent the adhesion of one substance to another. In the concrete construction industry, form release agents are commonly employed to prevent the adhesion of freshly placed concrete to the forming surface, which is typically constructed of plywood, overlaid plywood, steel or aluminum. Some release agents, known as “barrier” release agents, are designed to form a non-stick barrier between the concrete and forming surface. Others release agents are intended to induce a chemical reaction with the free limes of the concrete, thus creating a slippery film which prevents adhesion to the concrete forms.

Concrete release agents generally come in the form of a liquid and are conventionally applied to the surface of the concrete forms via the use of small commercial grade 1-3.5 Gal. capacity hand pump sprayers, such as that manufactured by Chapin International, Inc. The release agent, however, is typically delivered to the contractor in bulk, oftentimes in significantly larger containers, such as in a 55 Gal. drum, or even larger. Consequently, when working at a construction site, the contractor must repeatedly open and close the smaller hand held sprayers to refill the contents of the sprayer containers. For a typical construction job site, multiple hand pump sprayers are normally used to apply the release agent before pouring the concrete. While the smaller hand pump sprayers do provide flexibility by way of portability, they can be heavy, cumbersome to use, and require constant servicing which creates undesirable logjams in the construction project as a whole.

One common problem associated with the use of the smaller hand pump sprayer is contamination of the contents of the sprayer caused by repeated opening and closing of the sprayer container. When one of the smaller sprayers needs to be refilled, its fluid storage tank must be opened to allow additional release agent fluid to be pumped into the tank from a larger on-site bulk storage container. Each time this occurs, dirt, bugs and other potential contaminants are able to enter the spraying system, thus contaminating and eventually clogging the sprayer. With the considerable amount of dirt at a typical construction site, this problem can be significant. As the contaminants work their way through the sprayer wand, either partial or complete obstruction of the wand passageway and/or sprayer nozzle can occur. This causes uneven broadcasting of the release agent upon the concrete forming surface and eventual failure of the spraying equipment, requiring significant downtime for repair.

Furthermore, most conventional hand pump sprayers are pressurized by introducing air into the tank through an associated hand pump plunger mechanism. Repeated actuation of the hand pump plunger also causes the introduction of airborne contaminants into the fluid storage chamber, which further contaminates the sprayer system, resulting in the need for time consuming, costly repairs of the sprayer. Since conventional hand pump sprayers require continued pumping of the plunger mechanism to maintain internal pressure, potential clogging contaminants are continually being introduced into the spraying system. With multiple hand pump sprayers being used on each job site, there are even more opportunities for equipment failure. Such problems have an exacerbating trickle-down effect on all aspects of the construction project, leading to additional costly delays as the result of equipment failure, required repairs, etc.

In addition to the above, for large construction projects, the concrete forms are usually moved into position using a large crane. This not only facilitates ease in placement of the relatively large, heavy forms, but it also maintains the forms in an upright position so as to avoid dirt and other contaminants from contacting the forming surface. However, conventional hand pump sprayers are typically designed to be relatively small in compass such that they can be carried by the user and hand operated. Consequently, the spraying wand and connecting hose of the sprayer are usually relatively short, with limited reach. While beneficial for sprayer compactness, this complicates the application process of the release agents. With such limited reach, oftentimes it becomes extremely difficult for the user to apply a consistent, even coating of the release agent near the upper portions of the concrete forms. This can result in undesirable sticking of the concrete to the forming surface and an inferior end product.

Similarly, in order to apply a consistent, even coating of the release agent to the forming surface of a concrete form, it is desirable to maintain constant pressure within the sprayer. Without consistency of pressure, the broadcast spray will weaken and vary in consistency, thus leading to an uneven application or pattern of the release agent. With conventional hand pump sprayers, however, such consistency is difficult to sustain because they require continued hand pumping to maintain adequate internal pressure within the sprayer's fluid storage chamber. As pressure decreases within the fluid storage tank, the application of the release agent will vary in consistency, thus again leading to undesirable sticking of the concrete to the forming surface and an inferior end product.

Another problem associated with conventional sprayers is that substantial amounts of the release agent fluid can be lost during the application process when windy conditions are present at a construction site. The sprayer wands are designed to dispense the fluid in a fine mist pattern so as to spread the release agent evenly, but much of it often blows away in the wind, never reaching the target concrete form upon which it is to be applied.

For all of the foregoing reasons, it is evident that there is a significant need in the construction industry for an improved system for applying release agents to concrete forms which maintains the benefit of the portability of smaller hand pump sprayers, yet eliminates or significantly reduces the substantial problems associated with the introduction of contaminants into the spraying system. It would also be beneficial for such a system to have an extended reach capability and self-contained power system to facilitate mobility and application of a consistent coating of release agents to the concrete forms.

### SUMMARY

It is a primary object of the present invention to provide an improved dispensing device for the application of release agents to concrete forms which eliminates the need for the use of hand pump sprayers and the associated contamination problems therewith.

Another object of the present invention is to provide an improved portable dispensing system for concrete release agents which is designed to pump directly from a bulk fluid holding container utilizing a self-contained pump and power source connected thereto.

It is a further object of the present invention to utilize solar power to operate such a portable dispensing system so that a continuous supply of consistent energy can be maintained to operate a motorized pump of the system.

Still another object of the present invention is to provide a self-contained solar powered portable dispensing device that may be transported with a bulk supply of release agent fluid via pallet, so as to eliminate the need for continual refilling of smaller hand pump sprayers.

Still further, it is another object of the present invention to provide a portable release agent dispenser which has an extended wand assembly and long coilable hose to enhance the reach of such dispenser and facilitate consistent coating of the release agent to all portions of the forming surface upon which it is applied.

In furtherance of the foregoing objectives, and others, the present invention includes a large capacity bulk container (e.g., 55 Gal. drum) of a fluid concrete release agent mounted upon a supporting base, such as a pallet, that may be lifted for transportability about a construction site via the use of a skid loader or the like. Connected in sealed relation to and extending into the drum is an elongated fluid conveyance member, such as a suction hose, that is connected through a filtering device to the inlet of a 12 volt DC pump which operates a fluid dispensing wand. The outlet of the pump is fluidly connected to a hose reel upon which an extended (e.g. 100 ft.) dispensing hose is coiled and connected. The fluid dispensing wand, which is also preferably elongated (e.g., 4-12 ft.), is then connected to the free end of the dispensing hose.

To power the fluid pump of the system, a rechargeable 12 volt battery is provided, to which a solar panel is electrically connected as a source of constant renewable energy for charging the battery. The rechargeable battery is carried by the same supporting base as the bulk release agent container, and the solar panel, fluid pump and hose reel are all similarly mounted upon a frame assembly that is carried by the supporting base. Consequently, the entire concrete release agent dispensing system is incorporated upon the transportable supporting base as a self-contained unit.

With the 12 volt pump attached via a suction hose directly to the bulk container of release agent fluid, the connection is fluidly sealed and there is no need to continually open and replenish the dispensing device, as with conventional hand pump sprayers. Moreover, contaminated pressurized air no longer needs to be introduced into the dispensing system, as the 12 volt DC pump creates a negative pressure drawing the fluid up one side and a positive pressure on the opposite side to operate the dispensing wand. Consequently, there is little chance for contamination to enter the fluid dispensing system.

The wand assembly may be outfitted with a conventional spray nozzle attachment or, for use in more windy conditions, an optional mop-like dispensing element for applying the release agent to the surface of the concrete form. The 12 volt pump also creates a more constant pressure within the dispensing system, thus providing more consistency in the application of the release agent fluid to the forming surface of the concrete form. With less contamination and greater consistency in applying the release agent, fewer operators are necessary and less down time is required for repairs to the dispensing equipment. A more consistent application of the release agent helps to reduce the amount of fluid used on a construction project, further adding to the savings.

The solar panel and rechargeable battery carried on the support base with the bulk dispensing device functions to provide a constant, cost efficient source of renewable energy to power the fluid dispenser without the need for AC power, electrical cords, gas-powered generators, or the like. The entire unit may be self-contained on a readily movable pallet or the like, thus providing complete portability about the construction site. With the extended 100+ foot dispensing hose and extra-long wand assembly, the operator may cover larger areas of the forms in much less time and with greater ease.

The foregoing and additional features and advantages of the present invention will be more readily apparent from the following detailed description. It should be understood, however, that the description and specific examples herein are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic side elevational view of the present invention, comprising a self-contained portable solar powered fluid dispenser for use with concrete release agents and the like;

FIG. 2 is a perspective view of one exemplary embodiment of the present invention with a bulk container of release agent fluid and solar powered fluid pump mounted together as a self-contained unit on a transportable supporting base;

FIG. 3 is a close-up perspective view showing the mounting of and fluid connection between the pump and filter assembly of a self-contained fluid dispenser embodying the principles of my invention;

FIG. 4 is a perspective view of the reverse side of a similar fluid dispenser as shown in FIG. 2, showing a manual crank for the hose reel and an optional tank filler valve for filling smaller handheld spraying units;

FIG. 5 is a close-up perspective view of a control panel unit mounted to a self-contained fluid dispenser similar to that shown in previous embodiments, upon which various pump and solar panel control modules and gauges may be mounted; and

FIG. 6 is a diagrammatic view showing the manner in which the present invention may be utilized by an operator to spray a concrete form at a construction site while the form is being suspended in an upright position by a crane.

### DETAILED DESCRIPTION

The following description is merely exemplary in nature and is not intended to limit the present disclosure, application, or uses. It should be understood that throughout the drawings, corresponding reference numerals indicate like or corresponding parts and features.

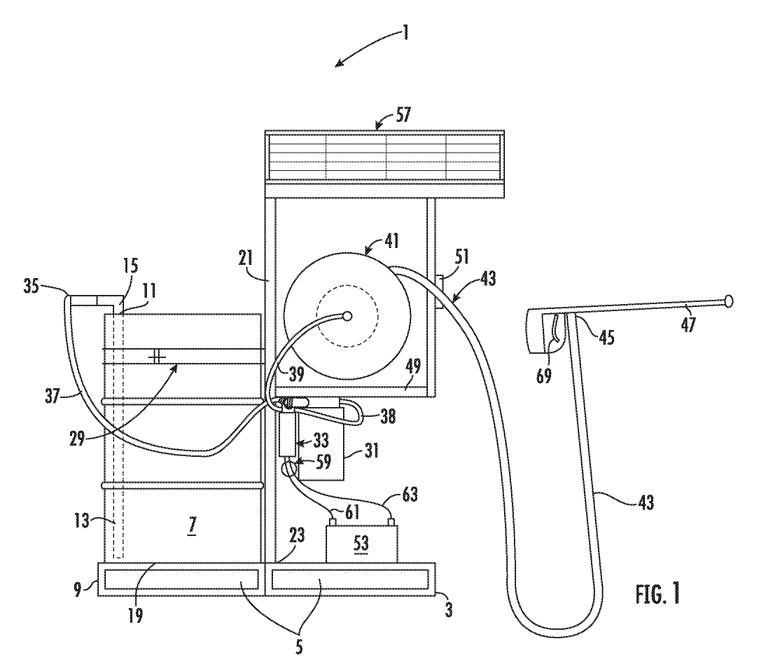

With reference now to the drawings, and particularly to FIG. 1, an exemplary embodiment is shown of a self-contained portable solar powered fluid dispenser 1 for the application of concrete release agent fluids. While the present discussion is in reference to fluid dispensers for concrete release agents, it will be appreciated that such a portable dispenser could be used in connection with other applications as well, such as for painting, irrigation, herbicides, etc. The dispenser 1 has a lower support base member 3, such as a pallet or the like. The base member 3 includes at least a pair of openings 5 which are adapted to receive the forks of a skid loader (not shown) or the like. In this manner, the entire portable fluid dispensing unit 1 may be easily hoisted from the ground and moved about the construction site as needed. Generally speaking, such a base pallet 3 is normally constructed of wood or metal, but could certainly be formed of other substantially rigid materials suitable for supporting all of the sprayer components.

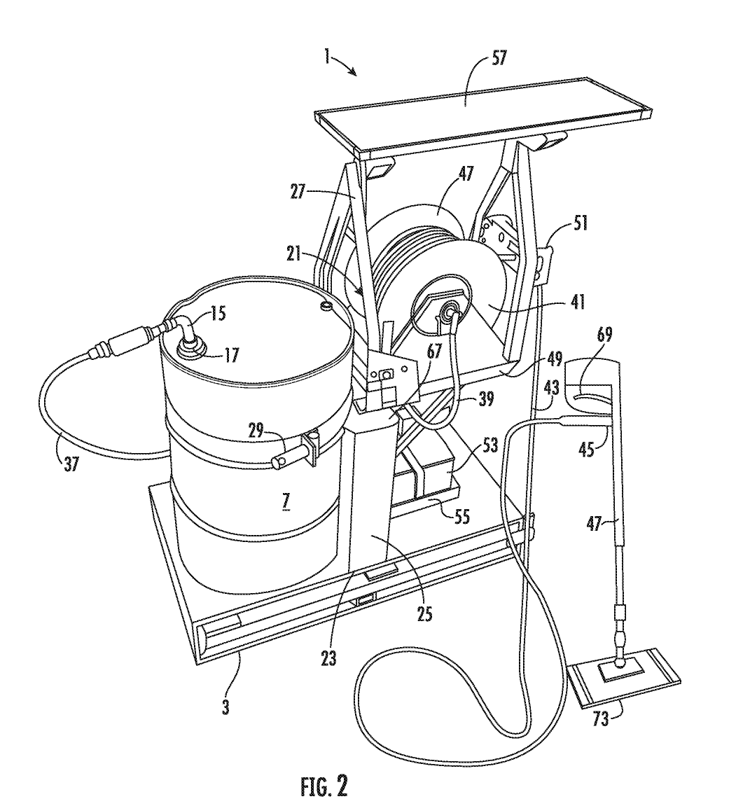

As shown in FIGS. 1 and 2, in one contemplated embodiment, a bulk container 7 of release agent fluid is stored upon the supporting base member 3 adjacent one side 9 thereof. The bulk container 7 could be composed of a fifty-five (55) gallon metal drum or other suitable large storage device within which the release agent fluid is delivered to the contractor. As best seen in FIG. 2, the upper end of the drum 7 includes a closable port 11 which may be opened for access to the interior contents. Extending through the port 11 is an elongated suction tube 13, the upper end 15 of which is connected in fluidly sealed relation (i.e., no exposure to external contamination, airborne or otherwise) to the drum 7 via a threaded fitting 17 or the like. As seen best in FIG. 1, the suction tube 13 extends into the interior of the drum 7 to a location closely adjacent the bottom 19 thereof.

As further shown in FIGS. 1, 2 and 4, a centrally disposed upright frame member 21 extends upward from the supporting base member 3 adjacent to drum 7. Frame member 21 is fixedly connected to support member 3 at its base 23. The frame 21 may be constructed in a number of ways, provided the structure is solid enough to support the various components of the fluid dispenser 1, as will be described in more detail below. It is contemplated that the frame 21 could be constructed entirely of a latticework of wood or metal capable of supporting the various components of the dispenser 1. In FIG. 2, however, the frame 21 is depicted as including a somewhat wider, more robust lower section 25 formed of metal, to which an upper metal frame section 27 is fixedly secured. Regardless of its construction, frame 21 provides necessary support and structural integrity to the entire portable fluid dispensing unit 1, such that it may be readily transported about the construction site without damage.

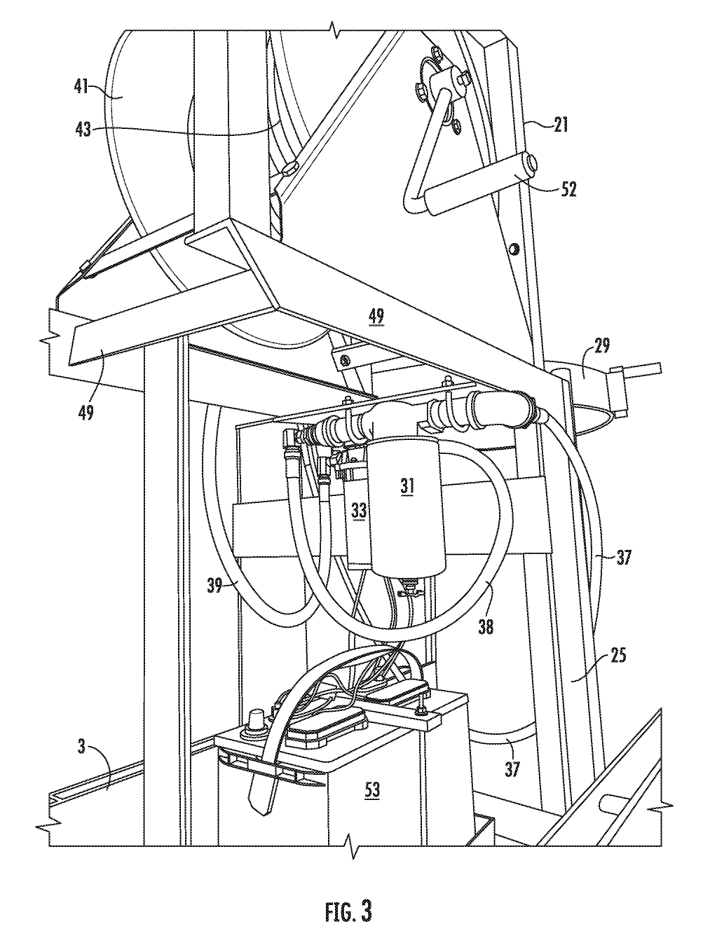

As seen best in FIGS. 1 and 2, a drum clamp 29 or other suitable securing means extends around the drum 7 and is secured to the frame 21 for support upon base member 3. Connected in fluidly sealed relation to the upper end 15 of the suction tube 13 is a fluid conveyance member, or connecting hose 37, which extends from the storage container 7 to a fluid filter 31. Fluid filter 31 simply provides reassurance that no potential contaminants carried within the stored release agent fluid can enter the pump 33 of the fluid dispensing unit 1. As best shown in FIG. 3, the fluid contained within drum 7 is drawn via pump 33 through hose 37 into fluid filter 31, where it exits through hose 38 to the input of fluid pump 33. In turn, pump 33 of the fluid dispensing unit 1 pushes the release agent fluid through fluid conveyance hose 39 to a large spool or hose reel 41 upon which an elongated dispensing hose 43 is fluidly connected and coiled. The free end 45 of the dispensing hose 43 is then connected to a dispensing wand 47, which may be 4-12 feet in length for extended reach. Accordingly, a fluidly sealed connection through pump 33 is created between the suction tube 13 within drum 7 and the dispensing wand 47.

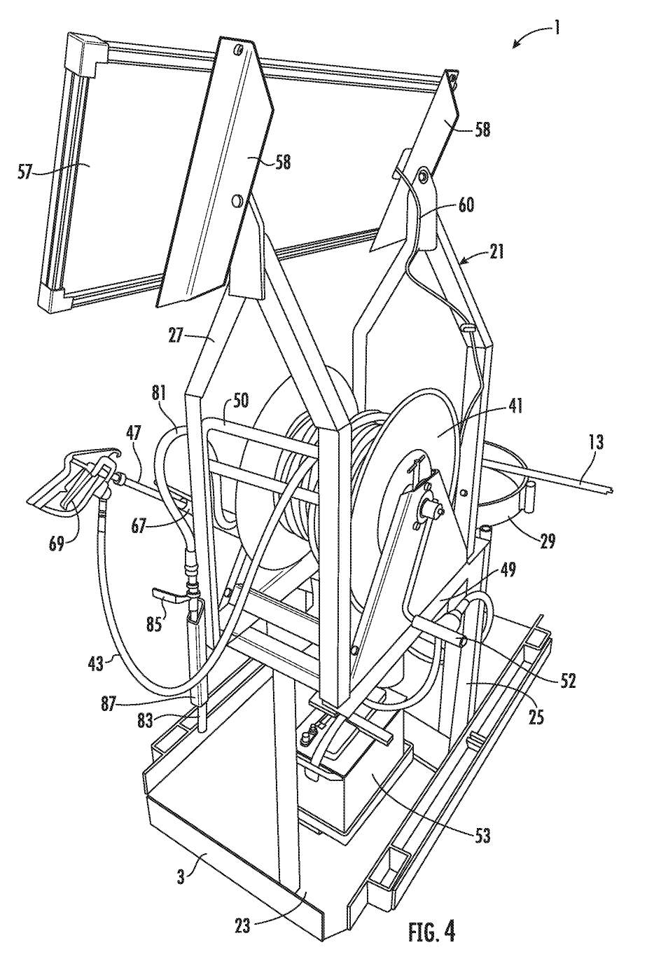

As shown in FIGS. 1 through 4, frame 21 includes an outwardly extending support platform 49 upon which the hose reel 41 is securely mounted. In a preferred embodiment, it is contemplated that the hose reel 41 be suitably sized to carry at least one hundred (100) feet of dispensing hose 43. As shown in FIG. 2, to help ensure proper coiling of the elongated dispensing hose 43 without tangling, an optional guide member 51 (through which hose 43 extends) may be carried by frame 21 in such position as to guide hose 43 onto and off the reel 41 during use. As shown best in FIG. 4, the hose 43 may alternatively be fed through a less restrictive open bracket 50 that is aligned with hose reel 41 to provide more flexibility and free movement of hose 43. Given the extended length of hose 43, it is contemplated that hose 43 preferably be composed of a highly flexible two-wire braided hydraulic hose, so as to impart maximum flexibility and versatility during use. It is further contemplated that reel 41 may be motorized or include a hand crank 52 for reeling and unreeling the dispensing hose 43.

Pump 33 is contemplated to be a twelve (12) volt DC pump, which is powered by a rechargeable battery 53 carried by and secured to the supporting base member 3. As shown in FIG. 2, a cradle 55 may be connected to the supporting base 3 for carrying the battery 53 and holding the same firmly in place during transportation about the construction site. A solar panel 57 is mounted atop frame 21 via a pair of pivotal mounting brackets 58, and is electrically connected to the rechargeable battery 53 through control line(s) 60. Accordingly, the rechargeable battery 53 will continually receive solar energy to maintain its electrical charge at full or near full capacity.

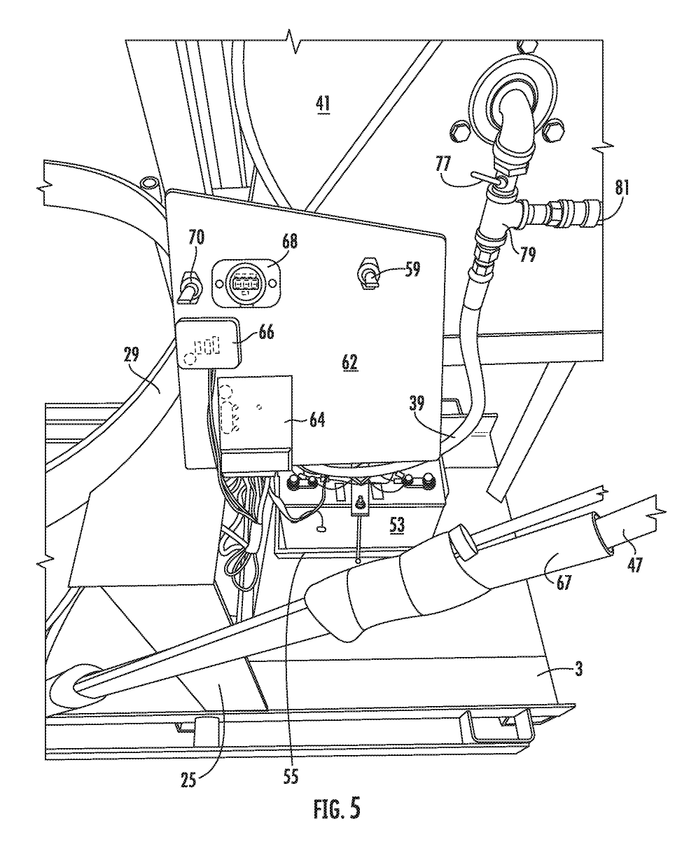

As illustrated diagrammatically in FIG. 1, in a manner well known in the art, the pump 33 is electrically connected through on/off toggle switch 59 to the positive and negative poles of battery 53 via electrical conductive lines 61 and 63. As shown best in FIG. 5, for ease of access, switch 59 may be mounted upon a central control panel 62 that is secured to the side of frame 21. Control panel 62 may also carry additional control modules and/or gauges pertaining to the battery and solar power system. For example, as show in the embodiment of FIG. 5, a solar power controller 64 and battery monitor 66 are shown mounted to control panel 62, as well as a voltage meter 68 with on/off switch 70 for monitoring the voltage of battery 53. Of course, other and additional control features could also be added to control panel 62 without departing from the invention herein.

Also, as further shown in FIG. 5, it is contemplated that connecting hose 39 leading from pump 33 to hose reel 41 may include an inline shutoff valve 77 located at or near the input to hose reel 41. Hose 39 may also include an inline tee fitting 79 to which an alternate fluid conveyance hose 81 may be connected. As best seen in FIG. 4, hose 81 leads to a terminal drain tube 83 that is adapted for use in filling conventional smaller handheld sprayers, if so desired, and for flushing the fluid dispensing unit 1 when needed. Shutoff valve 85 is connected in line with hose 83 so as to provide a control mechanism for the flow of fluid to drain tube 83 and prevent fluid from flowing there through until desired.

In use, the main shutoff valve 77 is normally open to allow the release agent fluid to flow into hose 43 carried on the hose reel 41. If it is desired to fill other smaller sprayers or flush the fluid dispenser 1, the shutoff valve 77 may be closed and valve 85 opened to pump fluid through the drain tube 83. When not in use, drain tube 83 may be stored in holder 87 which is affixed to a side portion of frame 21.

In a preferred embodiment, pump 33 is designed as an on-demand pumping system, such that pump 33 will operate only upon actuation of the handle trigger 69 on the dispensing wand 47. When the trigger 69 is released, pump 33 is designed to shut off, thus conserving the electrical energy produced by the rechargeable battery 53. With such an on-demand pumping system, the pump 33 is designed to sense the drop in fluid pressure produced by actuation of the dispensing wand trigger 69, thus activating pump 33. Upon release of trigger 69, the fluid pressure in pump 33 equalizes, thereby causing pump 33 to cease operation.

Although the use of an on-demand pumping system is preferred in that it will help conserve the electrical energy of the solar powered battery 53, it is also contemplated that pump 33 could be designed with a fluid bypass system which would allow pump 33 to continue running at all times the on/off switch 59 is switched to the “on” position. In such case, the pump 33 would continue to run regardless of whether the handle trigger 69 of the dispensing wand 47 is actuated or released. Of course, it will be understood by those skilled in the art that other possible configurations of the pumping system for the fluid dispensing unit 1 may be available for actuating the dispensing wand 47 without departing from the scope of the invention disclosed herein.

As noted previously, with the pump 33 being attached via connecting hoses 37 and 38 in fluidly sealed relation to suction tube 13 and bulk container 7 of release agent fluid, there is no need to continually open and replenish the contents of the fluid dispensing device. Therefore, contaminated pressurized air needs not be introduced into the dispensing system, as with conventional hand pump sprayers. The present dispensing device 1 is self-contained and remains sealed from the outer atmosphere. The twelve (12) volt DC pump 33 creates a negative pressure at its input to draw the release fluid out of container 7, and an opposite positive pressure at its output to operate the dispensing wand 47. Consequently, there is little chance for any contamination to enter the fluid dispensing system 1.

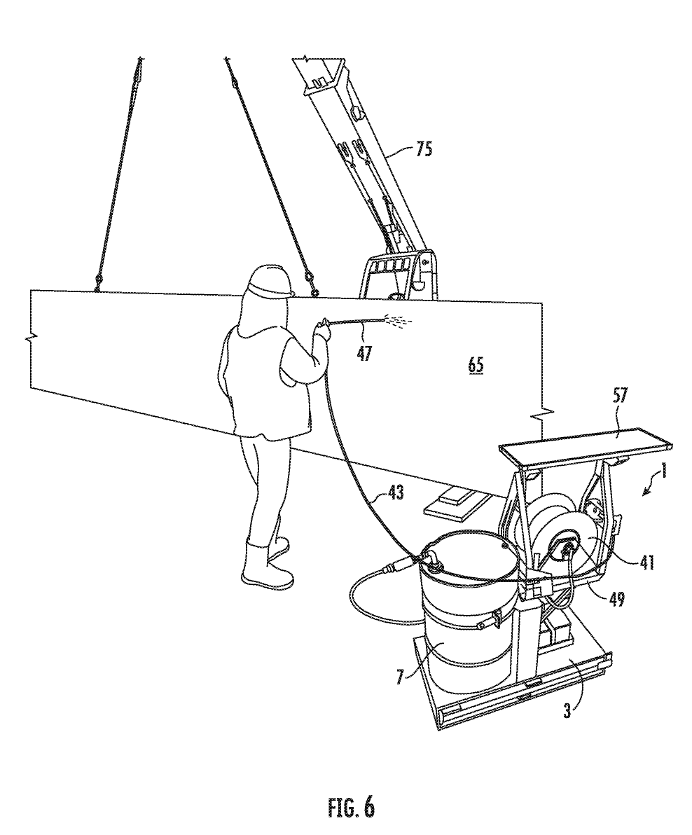

Moreover, with the solar panel 57 and rechargeable battery 53 being carried on the support base 3 with the bulk container 7, a constant, cost efficient source of renewable energy is readily available at all times to power pump 33 of the dispenser 1. Consequently, pump 33 creates a more constant pressure within the dispensing system 1 than conventional hand pump sprayers, thus providing more consistency in the application of the release agent fluid to the forming surface of the concrete form 65 (see, FIG. 6). With less contamination and greater consistency in applying the release agent, fewer operators are necessary and less down time is required for repairs to the dispensing equipment. A more consistent application of the release agent helps to reduce the amount of fluid used on a construction project, further adding to the savings.

By incorporating solar panel 57 and a solar powered rechargeable battery 53 as a source of readily renewable energy, pump 33 may be electrically energized without the need for long connecting electrical cords, gas-powered generators, or the like. Accordingly, the entire fluid dispensing unit 1 may be self-contained on a readily movable pallet 3 or the like, thus providing complete portability about the construction site using commonly employed construction equipment, such as a skid loader. With the extended 100+ foot dispensing hose 43 and extra-long wand assembly 47, the operator may cover larger areas of the forms 65 in much less time and with greater ease.

As shown in FIGS. 1 and 2, to apply the release agent fluid, wand assembly 47 may be outfitted with either a spray nozzle 71 (FIG. 1), or alternatively for windier conditions, a mop-like dispensing element 73 (FIG. 2). With reference to FIG. 6, it can be seen that a single operator using the present invention may treat large areas of concrete forms 65 by simply carrying the relatively light-weight dispensing wand 47 and uncoiling the extended dispensing hose 43 from the hose reel 41. The operator has complete mobility to spray (or mop) large areas without the inconvenience, burden and fatigue associated with carrying the much heavier, bulky fluid containers associated with conventional hand sprayers. With the sealed draw of release agent fluid from the bulk container 7 via the solar powered pump 33, virtually no contamination of the system is experienced, and a single operator can literally coat hundreds of feet of concrete forms with no need to refill, clean or repair the fluid dispensing system.

As shown further in FIG. 6, the wall form 65 may be supported in an upright position via a crane 75 or the like, such that the operator may conveniently walk along side of it and spray the form at ease with a consistent coating that requires less release agent fluid and results in a better, more even spray pattern overall. As best shown in FIGS. 4 and 5, upon completion, the hose 43 may be reeled up upon the hose reel 41, and the wand 47 may be inserted for safe keeping into a tubular storage casing 67 which is attached to frame 21.

The disclosure herein is intended to be merely exemplary in nature and, thus, variations that do not depart from the gist of the disclosure are intended to be within the scope of the disclosure. Therefore, it will be understood that various changes may be made in the form, details, arrangement and proportions of the parts without departing from the scope of the invention, which comprises the matter shown and described herein and set forth in the appended claims.

1. A self-contained portable solar powered fluid dispenser, comprising:
(a) a large capacity storage container for storing a bulk quantity of fluid;
(b) an electric powered fluid pump having an input port and an output port;
(c) a first fluid conveyance member for accessing the fluid within the storage container, the first fluid conveyance member maintaining a fluidly sealed connection between the input port of the fluid pump and the storage container;
(d) a second fluid conveyance member connected to the output port of the fluid pump and extending therefrom in fluidly sealed relation to a fluid dispensing wand;
(e) a rechargeable electric power source electrically connected in operating relation to the fluid pump;
(f) a solar energy collector connected in energizing relation to the electric power source; and
(g) a portable base platform upon which at least the storage container, the fluid pump, the electric power source and the solar energy collector are carried as a self-contained unit.

2. The self-contained fluid dispenser set forth in claim 1, wherein the second fluid conveyance member is substantially longer than the first fluid conveyance member.

3. The self-contained fluid dispenser set forth in claim 2, wherein the second fluid conveyance member is stored in coiled relation upon a rotatable spool carried on the portable platform.

4. The self-contained fluid dispenser set forth in claim 1, wherein the power source is electrically connected to the fluid pump through a power switch.

5. The self-contained fluid dispenser set forth in claim 1, wherein the first fluid conveyance member includes an inline filter for filtering out potential contaminants contained within the fluid.

6. The self-contained fluid dispenser set forth in claim 1, wherein the fluid dispensing wand includes a terminal mop mechanism for spreading the fluid as it is dispensed from the wand.

7. The self-contained fluid dispenser set forth in claim 1, wherein the solar energy collector is comprised of a solar panel.

8. The self-contained fluid dispenser set forth in claim 1, wherein the portable base platform is comprised of a pallet that may be transported using a fork lift.

9. The self-contained fluid dispenser set forth in claim 1, wherein the fluid pump is constructed to operate only upon sensing a fluid pressure differential between the input port and the output port.

10. The self-contained fluid dispenser set forth in claim 1, wherein the fluid dispensing wand is within the approximate range of 4-12 feet in length.

11. The self-contained fluid dispenser set forth in claim 1, including an upright frame attached to the base platform for supporting at least one member of the group consisting of the storage container, the fluid pump, the first fluid conveyance member, the second fluid conveyance member, the rechargeable power source and the solar energy collector.

12. The self-contained fluid dispenser set forth in claim 11, wherein the second fluid conveyance member is comprised of an elongated dispensing hose which is carried upon a retractable hose reel supported by the upright frame, the frame including a hose guide member for helping facilitate organized coiling of the dispensing hose upon the hose reel.

13. A self-contained portable solar powered fluid dispenser, comprising:
(a) a large capacity storage container for storing a bulk quantity of fluid;
(b) a solar powered electric fluid pump connected in fluidly sealed relation between the fluid storage container and a fluid dispensing wand, the fluid pump being constructed and arranged to extract the fluid from the storage container and dispense it at a substantially constant pressure and flow rate out through the wand in the form of a spray;
(c) a solar energy collector and rechargeable power source connected to said fluid pump for maintaining electrical power thereto as required during operation of the dispenser; and
(d) a portable base platform upon which the storage container, the fluid pump, the solar energy collector, the rechargeable power source and the dispensing wand are all carried as a self-contained unit.

14. The self-contained fluid dispenser set forth in claim 13, including an upright frame affixed to the base platform for supporting at least one member of the group consisting of the storage container, the fluid pump, the solar energy collector, the rechargeable power source and the dispensing wand.

15. The self-contained fluid dispenser set forth in claim 14, wherein the dispensing wand is attached to the fluid pump via an elongated dispensing hose which is carried upon a retractable hose reel supported by the upright frame, the frame including a hose guide member for helping facilitate organized coiling of the dispensing hose upon the hose reel.

16. The self-contained fluid dispenser set forth in claim 15, including a cranking mechanism for turning the retractable hose reel as needed to coil the elongated dispensing hose upon the reel.

17. The self-contained fluid dispenser set forth in claim 13, wherein the fluid pump is constructed to operate only upon sensing a fluid pressure differential between an input port to the pump and an output port to the pump.

18. The self-contained fluid dispenser set forth in claim 13, wherein the solar energy collector is comprised of a solar panel.

19. The self-contained fluid dispenser set forth in claim 17, including an on/off power switch connected electrically between the rechargeable power source and the fluid pump.

20. The self-contained fluid dispenser set forth in claim 13, including a fluid filtering member connected between the storage container and the fluid pump to help prevent possible contaminants within the fluid from entering the fluid pump.
